(19) United States
(12) Patent Application Publication
(10) Pub. No.: US 2003/0196434 A1
(43) Pub. Date: Oct. 23, 2003

(54) Multi-circuit flow ratio control

(76) Inventors: Bryan D. Brown, Peoria, IL (US); Roger D. Koch, Pekin, IL (US)

Correspondence Address: CATERPILLAR INC., 100 N.E. ADAMS STREET, PATENT DEPT., PEORIA, IL, 616296490

(21) Appl. No.: 10/092,121

(22) Filed: Mar. 6, 2002

Related U.S. Application Data
(60) Provisional application No. 60/339,609, filed on Dec. 11, 2001.

(51) Int. Cl. F16D 31/02

(52) U.S. Cl. 60/427

(57) ABSTRACT

A method for controlling a desired ratio of flow in a system having multiple circuits. The method includes determining a first desired flow in a first circuit and a second desired flow in a second circuit, determining a first actual flow in the first circuit and a second actual flow in the second circuit, comparing the first desired flow to the first actual flow and the second desired flow to the second actual flow, determining a condition of one of the first and second actual flows being less than the respective first and second desired flows, and responsively initiating a command from one of the first and second circuits to the other of the first and second circuits to reduce the actual flow of the other of the first and second circuits to maintain the desired ratio of flow.

This application claims the benefit of prior provisional patent application Serial No. 60/339,609, filed Dec. 11, 2001

### TECHNICAL FIELD

This invention relates generally to a method for controlling a flow in multiple circuits and, more particularly, to a method for controlling a ratio of flow in each circuit with respect to each other circuit.

### BACKGROUND

It is common in various technologies to provide a flow of some sort from a single source to multiple circuits. For example, in hydraulics, a single hydraulic pump may provide hydraulic fluid flow to multiple circuits, such as hydraulic cylinders. In another example, in electrical systems, a single power source commonly provides power or current to multiple electric circuits.

Quite often, it is desired to allocate the flow to the circuits as a ratio to insure that each circuit receives the proper flow. For example, in hydraulics, it is common to use multiple cylinder circuits to perform complex tasks, such as moving a device in a particular manner. A specific example might include a hydraulic excavator as an earthworking machine. A bucket is used to move material such as earth. The bucket may be attached to a stick, which is attached to a boom, which in turn is attached to the machine. The boom, stick and bucket may all be controlled independently by separate hydraulic circuits, each circuit having one or more cylinders. A single pump typically provides flow to each of the circuits. Since movement of the bucket involves complex and interrelated control of each cylinder in each circuit, it is paramount that the pump provide flow in the proper desired amounts and ratios. Failure to provide the desired flows would result in loss of control of the movement of the bucket, and hence impede optimal performance of the machine.

In multiple circuit configurations having a single source, such as described above, factors such as circuit design and external loads can cause actual circuit flow to vary appreciably from desired circuit flow, thus making it difficult if not impossible to maintain the desired ratios of flows.

The present invention is directed to overcoming one or more of the problems as set forth above.

### SUMMARY OF THE INVENTION

In one aspect of the present invention a method for controlling a desired ratio of flow in a system having multiple circuits is disclosed. The method includes the steps of determining a first desired flow in a first circuit and a second desired flow in a second circuit, determining a first actual flow in the first circuit and a second actual flow in the second circuit, comparing the first desired flow to the first actual flow and the second desired flow to the second actual flow, determining a condition of one of the first and second actual flows being less than the respective first and second desired flows, and responsively initiating a command from one of the first and second circuits to the other of the first and second circuits to reduce the actual flow of the other of the first and second circuits to maintain the desired ratio of flow.

In another aspect of the present invention a method for controlling a desired ratio of flow in a system having multiple circuits is disclosed. The method includes the steps of determining a desired flow in each of the multiple circuits, determining an actual flow in each of the multiple circuits, comparing each desired flow to each respective actual flow, determining a condition of at least one circuit having an actual flow less than the respective at least one desired flow, and responsively initiating a command from the at least one circuit having an actual flow less than the desired flow, the command being delivered to at least one other circuit to reduce the actual flow of the at least one other circuit to maintain the desired ratio of flow.

### BRIEF DESCRIPTION OF THE DRAWINGS

FIG. 1 is a block diagram illustrating a system for use with the present invention;

FIG. 2a is a control diagram illustrating a first independent circuit;

FIG. 2b is a control diagram illustrating a second independent circuit;

FIG. 3 is a control diagram illustrating a preferred embodiment of the present invention;

FIG. 4 is a simplified version of the control diagram of FIG. 4;

FIG. 5 is a flow diagram illustrating one embodiment of the present invention; invention;

FIG. 6 is a flow diagram illustrating another embodiment of the present invention;

FIG. 7 is a flow diagram illustrating yet another embodiment of the present invention; and

FIG. 8 is a flow diagram illustrating still another embodiment of the present invention.

### DETAILED DESCRIPTION

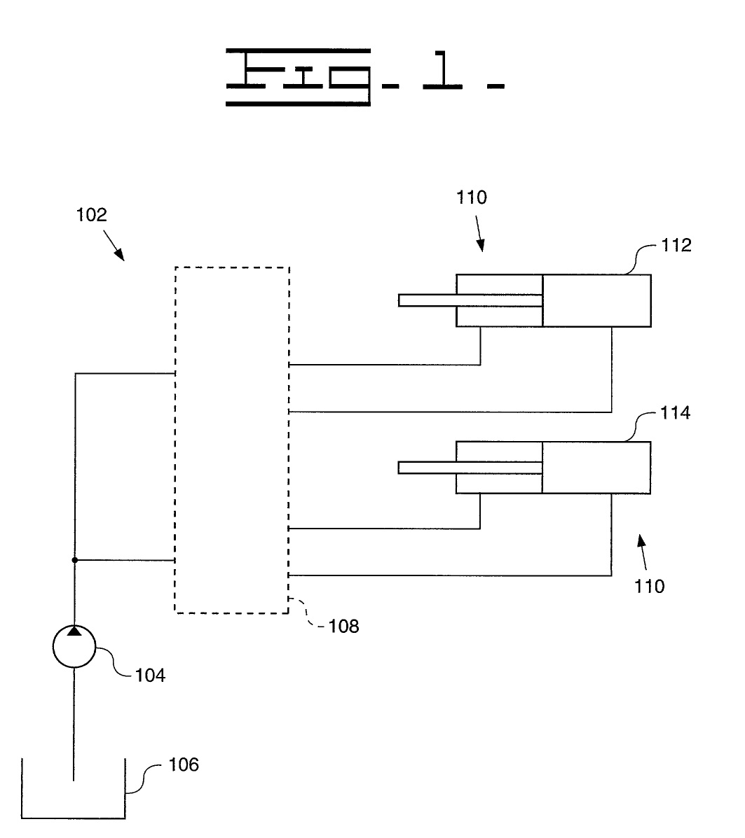

Referring to FIG. 1, a hydraulic system 102 (hereinafter referred to as “system”) is shown which is suited for use with the present invention. A pump 104 provides pressurized hydraulic fluid to the system 102. A tank 106 provides a reservoir of hydraulic fluid. The pump 104 and the tank 106 act in coordination as a source of hydraulic power. The pump 104 and the tank 106, as a source, supply a flow of hydraulic fluid to the system 102.

Additional hydraulic circuitry 108, such as valves and the like (not shown), are an integral part of the system 102, but are not needed for a discussion of the present invention.

At least one hydraulic cylinder 110 (hereinafter referred to as “cylinder”) is included in the system 102. For example, in FIG. 1, a first cylinder 112 and a second cylinder 114 are shown. The cylinders 110 are used to perform the work which the system 102 is designed for.

It is noted that, although the system 102 is depicted as a hydraulic system, other types of systems may also be used with the present invention. For example, an electrical system may be used. In this case, the pump 104 and tank 106, acting as a hydraulic power source, may be replaced by an electrical power source, such as a generator, battery, solar cells and the like. The hydraulic circuitry 108 may be replaced with electrical circuitry, and the cylinders 110 may be replaced with suitable electrical components, such as motors, starters, activators, electronic components, and such.

As another example, the system 102 may be a mechanical system, having a mechanical power source, such as a motor, gearing, transmission, engine and the like, replacing the pump 104 and tank 106. Additional mechanical components, such as gears, levers, springs and such, may replace the hydraulic circuitry 108, and mechanical work components, such as final drives, wheels, tracks, work tools, and such, may replace the cylinders 110.

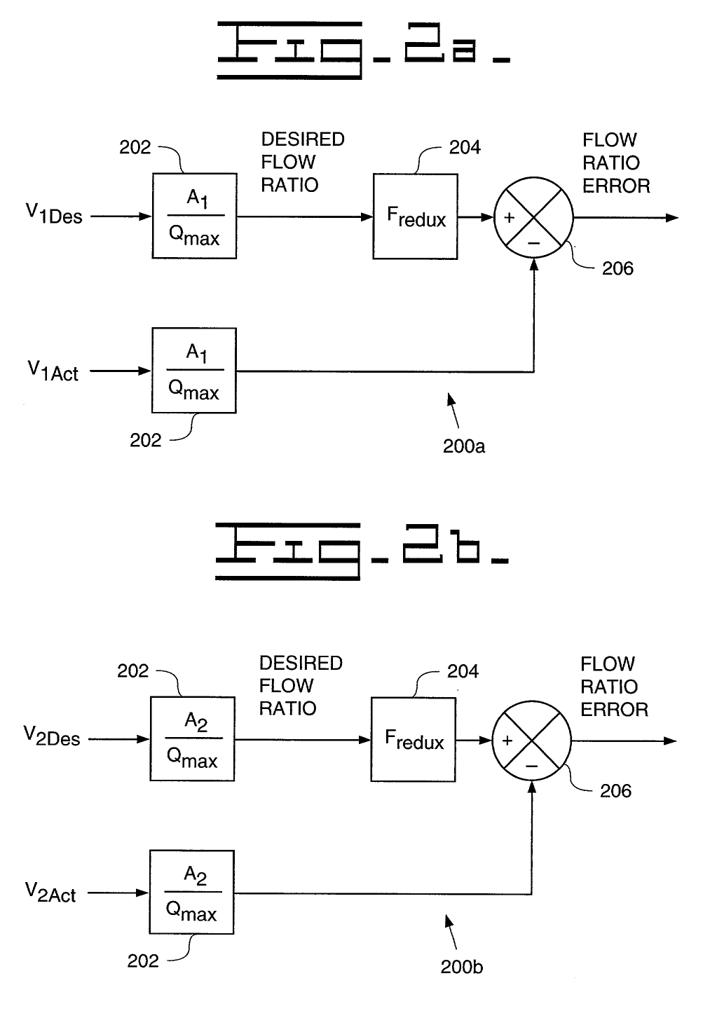

Referring to FIGS. 2a and 2b, control diagrams illustrating flow in independent systems are shown. FIG. 2a represents a first circuit 200a and FIG. 2b represents a second circuit 200b. The term “flow” in the context of hydraulic systems refers to the flow of hydraulic fluid. In other types of systems, for example electrical systems, the term “flow” refers to other types of flow, for example, the flow of electrical current. The remaining discussion below, unless otherwise noted, refers to hydraulic systems.

In the preferred embodiment, a velocity of each cylinder 110 is initially determined. The velocity refers to the speed which the cylinder 110 moves, i.e., the speed which a rod (not shown) within the cylinder 110 moves either into or out of the cylinder 110. The velocity of the cylinder 110 is a direct function of the flow of hydraulic fluid through the cylinder 110. More specifically, the relationship may be approximated by:

Q=A*V (Eq. 1)

where Q is the flow, A is the bore area of the cylinder 110, and V is the velocity of the cylinder. The velocity of the cylinder 110 is normally easier and more practical to measure directly than is the flow.

A conversion block 202 converts the velocity of the cylinder 110 to flow. For example, in FIG. 2a, V_{1Des}, the desired velocity in the first circuit 200a, is converted to flow by a conversion block 202, and V_{1Act}m the actual velocity in the first circuit 200a, is converted to flow by a conversion block 202. A similar conversion takes place in FIG. 2b.

The outputs of the conversion blocks 202 which convert the desired velocities to desired flows are denoted as “Desired Flow Ratio”. In one embodiment, the desired flow ratio refers to a ratio of the desired flow to the maximum flow available. For example, if it is desired for each circuit 200a,200b to have one half of the maximum available flow, the desired flow ratio would be one to two (1:2). In an alternate embodiment, the desired flow is not denoted as a ratio to maximum flow, and a ratio of flows between circuits, e.g., the flow of the first circuit 200a compared to the flow of the second circuit 200b, is denoted. For example, if it is desired that the flow of the first circuit 2001 be one third of the flow of the second circuit 200b, the flow ratio would be one to three (1:3).

Reduction blocks 204 are used, if desired, as reduction factors for the desired flow. For example, if it is determined that the sum of the desired flows for the first and second circuits 200a,200b exceeds the maximum amount of flow available, the reduction blocks 204 will reduce the desired flows by a specified amount. The reduction may be equally distributed among the circuits or may be based on some proportion as a function of circuit priority.

Summers 206 compare the desired flows to the actual flows and produce a “Flow Ratio Error”. If the desired flow of a circuit exceeds the actual flow, the circuit is determined to not be receiving a “fair share” of flow. Alternatively, if the desired flow is less than the actual flow, the circuit is determined to be receiving more than a “fair share” of flow.

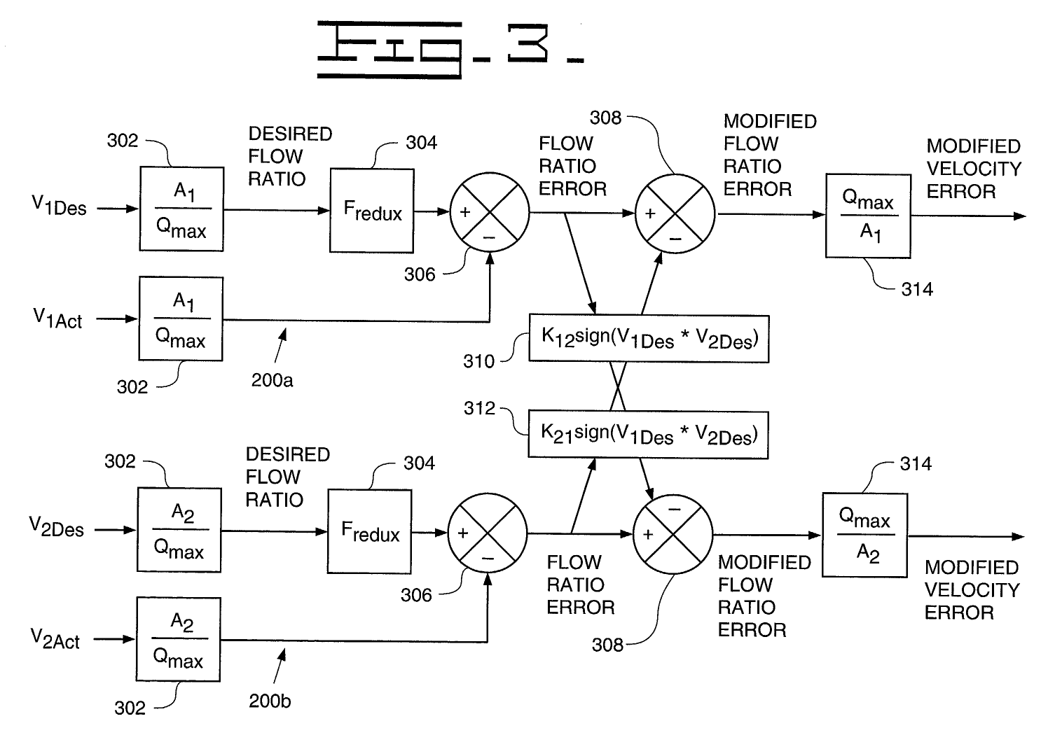

Referring to FIG. 3, a control diagram illustrating a preferred embodiment of the present invention is shown. The first and second circuits 200a,200b are identical to the diagrams of FIGS. 2a and 2b up through the summers 206, which are now depicted as first summers 306. At the output of the first summers, however, a portion of the control path is diverted to cross control blocks. For example, a portion of the control path of the first circuit 200a is diverted to a first cross control block 310, and a portion of the control path of the second circuit 200b is diverted to a second cross control block 312. The first cross control block 310 is a circuit 1 to circuit 2 control, i.e., the first circuit 200a has some control over the flow of the second circuit 200b. The second cross control block 312 is a circuit 2 to circuit 1 control, i.e., the second circuit 200b has some control over the flow of the first circuit 200a.

Preferably, the cross control blocks 310,312 include control algorithms, for example:

K₁₂sign(V_{1Des*V}_{2Des}) (Eq. 2)

and

K₂₁sign(V_{1Des}*V_{2Des}) (Eq. 3)

where K₁₂ and K₂₁ are gain factors, and may be constants or may be variables, maps, tables and the like to customize the behavior and the response of the circuits in any desired manner.

Command signals from the cross control blocks 310,312 are delivered to second summers 308. The second summers 308 also receive the flow ratio errors from the first summers 306. For example, the second summer 308 in the first circuit 200a receives the flow ratio error from the first summer 306 and also receives a command signal from the second cross control block 312. The second summer 308 then produces a modified flow ratio error. The second summer 308 in the second circuit 200b receives the flow ratio error from the first summer 306 and also receives a command signal from the first cross control block 310.

In the preferred embodiment, if the first circuit 200a is not receiving a “fair share” of flow, K₁₂ tends to reduce flow to the second circuit 200b. If the second circuit 200b is receiving more than a “fair share” of flow, K₂, tends to increase flow to the first circuit 200a. This process continues until the desired ratio of flow in both circuits 200a,200b is attained.

Second conversion blocks 314 receive the modified flow ratio errors and convert them to modified velocity errors, i.e., modified errors in the velocities of the cylinders 110.

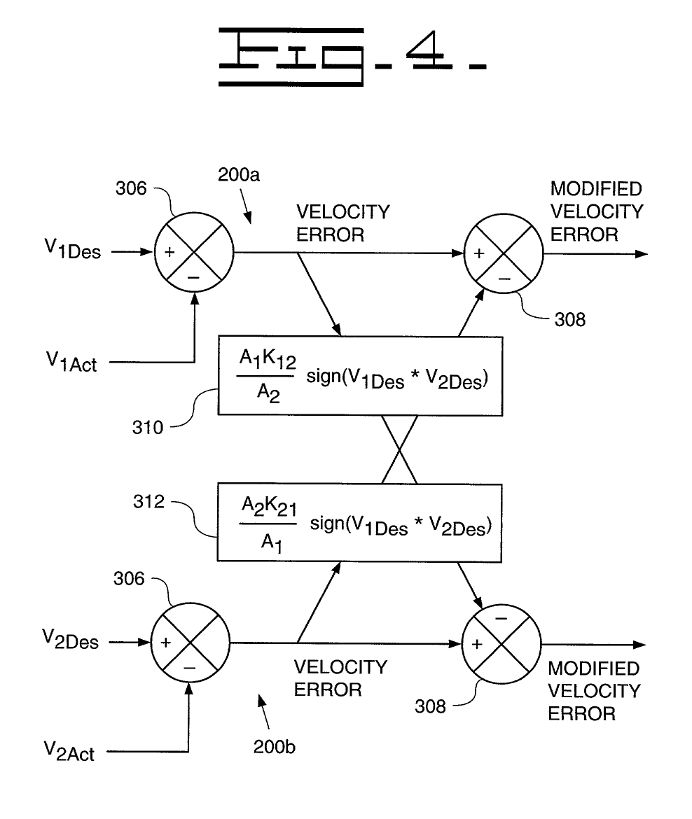

Referring to FIG. 4, a simplified version of the control diagram of FIG. 3 is shown. In the FIG. 4 embodiment, the reduction blocks 204,304 have been removed. Furthermore, the control diagram does not convert velocity of the cylinders 110 to flow, nor convert back to velocities. Rather than flow errors being determined, velocity errors are determined directly. The algorithms in the cross control blocks 310, 312 are modified slightly to account for the different procedures. Exemplary algorithms may be expressed as:

$$\begin{matrix}\frac{{A}_{1} {K}_{12}}{{A}_{2}} sign ( {V}_{1 Des} * {V}_{2 Des} ) and & ( Eq . 4 ) \\ \frac{{A}_{2} {K}_{21}}{{A}_{1}} sign ( {V}_{1 Des} * {V}_{2 Des} ) . & ( Eq . 5 )\end{matrix}$$

In equation form, the modified velocity error for the first circuit 200a may be expressed as:

$$\begin{matrix}{V}_{1 Err Modified} = {V}_{1 Err} - \frac{{A}_{2} {K}_{21}}{{A}_{1}} * {V}_{2 Err} * \\ sign ( {V}_{1 Des} * {V}_{2 Des} ) .\end{matrix} \qquad ( Eq . 6 )$$

In like manner, a similar equation may express the modified velocity error for the second circuit 200b.

The method described above may be extended to any number of circuits. For example, in matrix format:

{V_{Err Modified}}=[A Sign(V_{Des})][K][A⁻¹Sign(V_{Des})]{V_{Err}} (Eq. 7)

where [A sign(V_{Des})] is a diagonal matrix of effective cylinder areas, K is a weighting matrix, and {V_{Err Modified}} and {V_{Err}} are vectors.

For example, a system 102 having four (4) circuits could be implemented in matrix format as:

$$\begin{matrix}\{ \begin{matrix}{V}_{1 Err Modified} \\ {V}_{2 Err Modified} \\ {V}_{3 Err Modified} \\ {V}_{4 Err Modified}\end{matrix} \} = [ A sign ( {V}_{Des} ) ] [ \begin{matrix}1 & {K}_{12} & {K}_{13} & {K}_{14} \\ {K}_{21} & 1 & {K}_{23} & {K}_{24} \\ {K}_{31} & {K}_{32} & 1 & {K}_{34} \\ {K}_{41} & {K}_{42} & {K}_{43} & 1\end{matrix} ] \\ [ {A}^{- 1} sign ( {V}_{Des} ) ] \{ \begin{matrix}{V}_{1 Err} \\ {V}_{2 Err} \\ {V}_{3 Err} \\ {V}_{4 Err}\end{matrix} \}\end{matrix} \qquad ( Eq . 8 )$$

Individual elements of the weighting matrix K may be chosen to give each circuit equal priority or to favor one circuit over another. For example, individual elements may be constants or they may be variables which vary as a function of time, flow and the like.

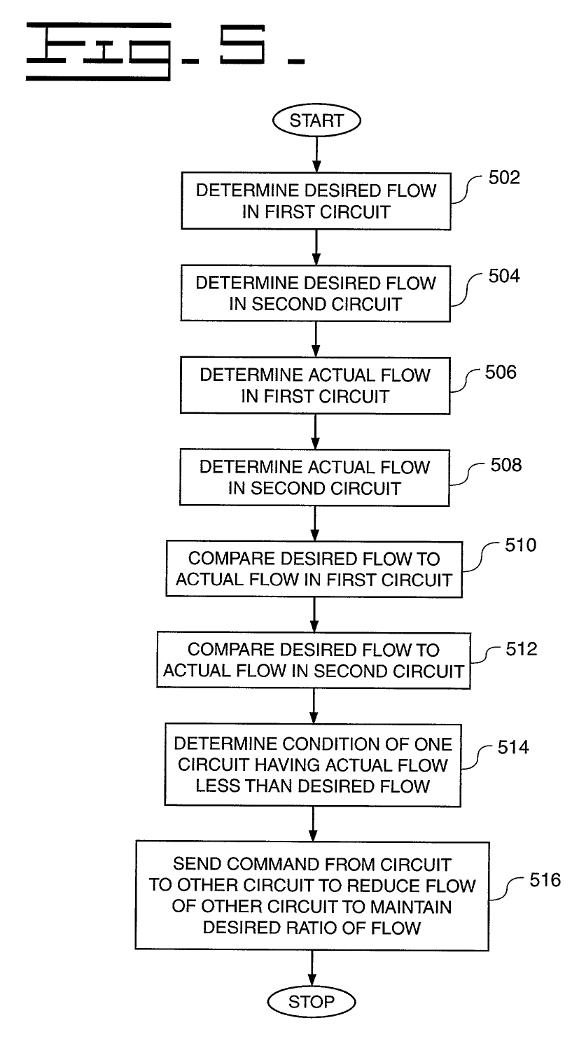

Referring to FIG. 5, a flow diagram illustrating a preferred embodiment of the method of the present invention is shown.

In a first control block 502, a desired flow in a first circuit 200a is determined. In a second control block 504, a desired flow in a second circuit 200b is determined. In a third control block 506, an actual flow in the first circuit 200a is determined. In a fourth control block 508, an actual flow in the second circuit 200b is determined. In a fifth control block 510, the desired flow in the first circuit 200a is compared to the actual flow in the first circuit 200a. In a sixth control block 512, the desired flow in the second circuit 200b is compared to the actual flow in the second circuit 200b.

Control proceeds to a seventh control block 514, in which a condition is determined of one circuit having an actual flow less than the desired flow. Consequently, control proceeds to an eighth control block 516, in which a command from one circuit, e.g., the circuit having a reduced actual flow, is sent to the other circuit to reduce the flow of the other circuit, thus maintaining a desired ratio of flow between the circuits.

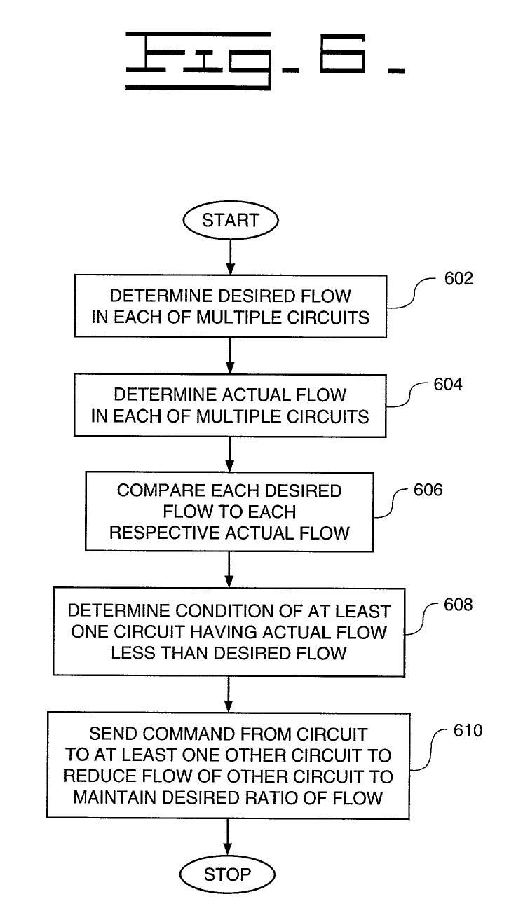

Referring to FIG. 6, a flow diagram illustrating another embodiment of the method of the present invention is shown. The flow diagram of FIG. 6 essentially expands the method depicted in the flow diagram of FIG. 5 to include a system 102 having multiple, e.g., more than two (2), circuits.

In a first control block 602, a desired flow of each circuit is determined. In a second control block 604, an actual flow of each circuit is determined. In a third control block 606, each desired flow is compared to each respective actual flow. In a fourth control block 608, a condition is determined of at least one circuit having an actual flow less than the corresponding desired flow. Control then proceeds in response to a fifth control block 610, in which a command is sent from any circuit having a reduced actual flow to one or more other circuits to reduce the flow of those other circuits to maintain a desired ratio of flow. Preferably, this is accomplished using matrix equation 7, of which Equations 8, 9 and 10 are exemplary of a system 102 having four (4) circuits.

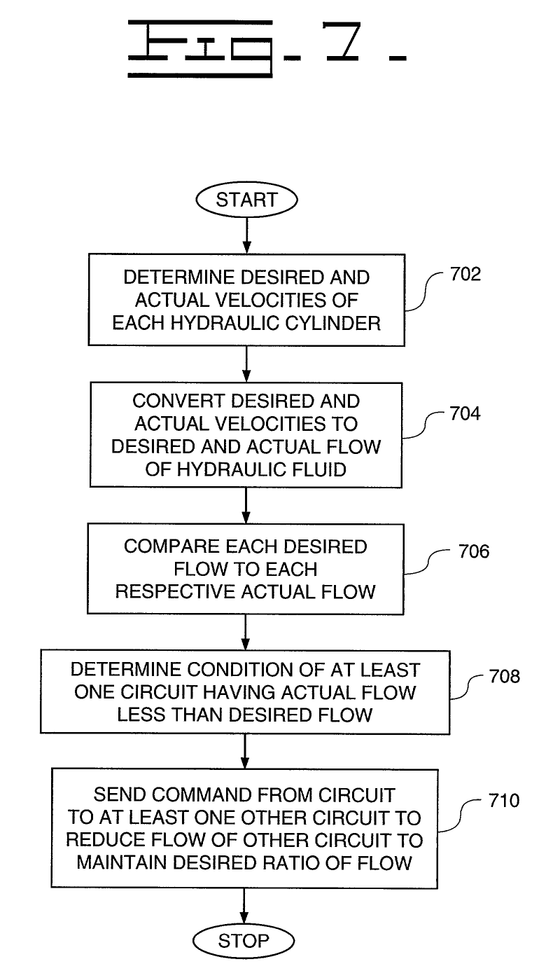

Referring to FIG. 7, a flow diagram illustrating yet another embodiment of the method of the present invention is shown.

In a first control block 702, desired and actual velocities of each cylinder 110 are determined. Preferably, the cylinder velocities are determined by techniques well known in the art, such as sensing cylinder position and differentiating the results.

In a second control block 704, the desired and actual velocities are converted to respective desired and actual flows of hydraulic fluid, as described above. In a third control block 706, each desired flow is compared to each respective actual flow. In a fourth control block 708, a condition is determined of at least one circuit having an actual flow that is less than the corresponding desired flow. Responsively, in a fifth control block 710, a command is sent from any circuits having a reduced actual flow to one or more other circuits, reducing the flow of those other circuits to maintain the desired flow ratio.

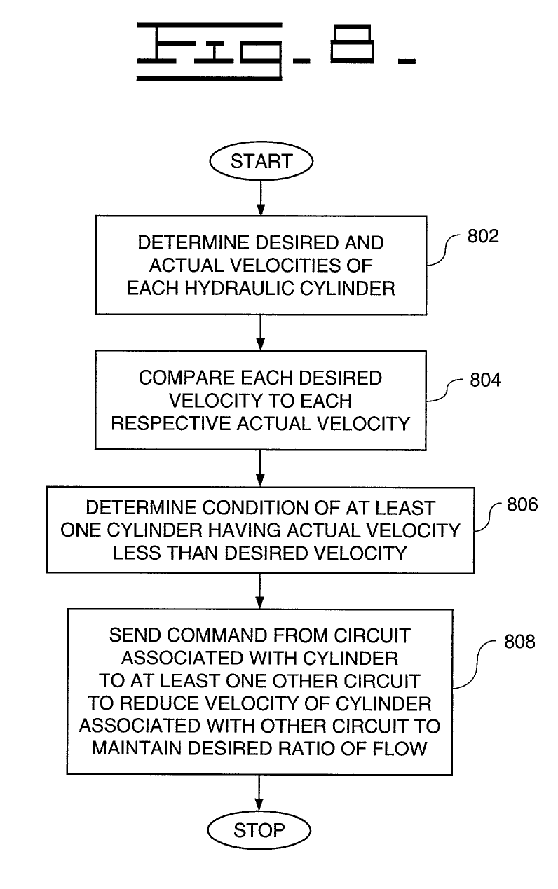

Referring to FIG. 8, a flow diagram illustrating still another embodiment of the method of the present invention is shown.

In a first control block 802, the desired and respective actual velocities of each cylinder 100 are determined. In a second control block 804, each desired velocity is compared to each respective actual velocity. In a third control block 806, a condition is determined of at least one cylinder 110 having an actual velocity that is less than a corresponding desired velocity. Control responsively proceeds to a fourth control block 808, in which a command is sent from any circuits having a cylinder 110 having a reduced actual velocity to one or more other circuits to reduce the velocity of cylinders 110 in those other circuits to maintain the desired ratio of velocities, and thus to maintain the desired ratio of flow.

### INDUSTRIAL APPLICABILITY

As an example of an application of the present invention, a system 102 having multiple circuits must typically use a source of power to provide a flow of some type to each circuit. Each circuit must be able to receive a desired flow for the overall system to function properly. For example, a work machine, such as a hydraulic excavator, has multiple hydraulic circuits, each having one or more hydraulic cylinders to perform some task, such as controllably moving a boom, stick, or bucket. The movements of the various components of the excavator must be coordinated to achieve a desired overall motion of the machine. For example, it may be desired to move the bucket along a straight-line path to clear debris or dig a trench. The straight-line path is dependent on the coordinated, simultaneous movements of the boom, stick and bucket. Hydraulic flow, therefore, must be provided to each circuit at the desired rates, or the overall motion will not be as desired. The present invention is adapted to determine a reduced flow in any of the circuits and responsively control one or more remaining circuits to maintain the desired flows, or alternatively to maintain a desired ratio of flows.

Although the example just described is with respect to a hydraulic system, the present invention is equally suited for application with other types of systems, such as electrical and mechanical systems, as described above.

Other aspects, objects, and features of the present invention can be obtained from a study of the drawings, the disclosure, and the appended claims.

What is claimed is:

1. A method for controlling a desired ratio of flow in a system having multiple circuits, including the steps of:
determining a first desired flow in a first circuit and a second desired flow in a second circuit;
determining a first actual flow in the first circuit and a second actual flow in the second circuit;
comparing the first desired flow to the first actual flow and the second desired flow to the second actual flow;
determining a condition of one of the first and second actual flows being less than the respective first and second desired flows; and
responsively initiating a command from one of the first and second circuits to the other of the first and second circuits to reduce the actual flow of the other of the first and second circuits to maintain the desired ratio of flow.

2. A method, as set forth in claim 1, further including the steps of:
determining a condition of the other of the first and second actual flows being greater than the respective first and second desired flows; and
responsively initiating a command from the other of the first and second circuits to the one of the first and second circuits to increase the actual flow of the one of the first and second circuits to maintain the desired ratio of flow.

3. A method, as set forth in claim 2, wherein the system is a hydraulic system, and wherein determining a first and a second desired flow and a first and a second actual flow include the steps of determining a first and a second desired flow of hydraulic fluid and a first and a second actual flow of hydraulic fluid.

4. A method, as set forth in claim 3, wherein the hydraulic system includes a first and a second hydraulic cylinder, and wherein determining a first and a second desired flow of hydraulic fluid and a first and a second actual flow of hydraulic fluid include the steps of determining a first and a second desired velocity of the respective first and second hydraulic cylinder and a first and a second actual velocity of the respective first and second hydraulic cylinder.

5. A method, as set forth in claim 4, further including the steps of converting the first and second desired velocity to a respective first and second desired flow and the first and second actual velocity to a respective first and second actual flow.

6. A method, as set forth in claim 2, wherein the system is an electrical system, and wherein determining a first and a second desired flow and a first and a second actual flow include the steps of determining a first and a second desired flow of electric current and a first and a second actual flow of electric current.

7. A method for controlling a desired ratio of flow in a system having multiple circuits, including the steps of:
determining a desired flow in each of the multiple circuits;
determining an actual flow in each of the multiple circuits;
comparing each desired flow to each respective actual flow;
determining a condition of at least one circuit having an actual flow less than the respective at least one desired flow; and
responsively initiating a command from the at least one circuit having an actual flow less than the desired flow, the command being delivered to at least one other circuit to reduce the actual flow of the at least one other circuit to maintain the desired ratio of flow.

8. A method, as set forth in claim 7, further including the steps of:
determining a condition of at least one of the other of the at least one circuit having an actual flow greater than the respective desired flow; and
responsively initiating a command from the at least one of the other of the at least one circuit to the at least one circuit having an actual flow less than the desired flow to increase the actual flow of the at least one circuit having an actual flow less then the desired flow to maintain the desired ratio of flow.

9. A method, as set forth in claim 8, wherein the system is a hydraulic system, and wherein determining a desired flow and a respective actual flow in each of the multiple circuits include the steps of determining a desired flow and a respective actual flow of hydraulic fluid in each of the multiple circuits.

10. A method, as set forth in claim 9, wherein the hydraulic system includes a plurality of hydraulic cylinders, at least one hydraulic cylinder being associated with a corresponding one of the multiple circuits, and wherein determining a desired flow and a respective actual flow of hydraulic fluid in each of the multiple circuits include the steps of determining a desired velocity and a respective actual velocity of each hydraulic cylinder.

11. A method, as set forth in claim 10, further including the steps of converting each desired velocity to a respective desired flow of hydraulic fluid and each actual velocity to a respective actual flow of hydraulic fluid.

12. A method, as set forth in claim 8, wherein the system is an electrical system, and wherein determining each desired flow and each actual flow include the steps of determining a desired flow of electric current for each circuit and an actual flow of electric current for each respective circuit.

13. A method for controlling a desired ratio of flow of hydraulic fluid in a hydraulic system having multiple hydraulic circuits, including the steps of:
determining a desired flow of hydraulic fluid in each of the multiple hydraulic circuits;
determining an actual flow of hydraulic fluid in each of the multiple hydraulic circuits;
comparing each desired flow of hydraulic fluid to each respective actual flow of hydraulic fluid;
determining a condition of at least one hydraulic circuit having an actual flow of hydraulic fluid less than the respective at least one desired flow of hydraulic fluid; and
responsively initiating a command from the at least one hydraulic circuit having an actual flow of hydraulic fluid less than the desired flow of hydraulic fluid, the command being delivered to at least one other hydraulic circuit to reduce the actual flow of hydraulic fluid of the at least one other hydraulic circuit to maintain the desired ratio of flow of hydraulic fluid.

14. A method for controlling a desired ratio of flow of hydraulic fluid in a hydraulic system having multiple hydraulic circuits, each hydraulic circuit having at least one hydraulic cylinder associated therewith, including the steps of:
determining a desired and an actual velocity of each hydraulic cylinder;
converting the desired and actual velocity to a desired and actual flow of hydraulic fluid;
comparing the desired flow of hydraulic fluid to the actual flow of hydraulic fluid;
determining a condition of at least one hydraulic circuit having an actual flow of hydraulic fluid less than the respective at least one desired flow of hydraulic fluid; and
responsively initiating a command from the at least one hydraulic circuit having an actual flow of hydraulic fluid less than the desired flow of hydraulic fluid, the command being delivered to at least one other hydraulic circuit to reduce the actual flow of hydraulic fluid of the at least one other hydraulic circuit to maintain the desired ratio of flow of hydraulic fluid.

15. A method for controlling a desired ratio of flow of hydraulic fluid in a hydraulic system having multiple hydraulic circuits, each hydraulic circuit having at least one hydraulic cylinder associated therewith, including the steps of:
determining a desired and an actual velocity of each hydraulic cylinder;
comparing the desired velocity to the actual velocity;
determining a condition of at least one hydraulic cylinder having an actual velocity less than the respective at least one desired velocity; and
responsively initiating a command from the at least one hydraulic circuit associated with the at least one hydraulic cylinder having an actual velocity less than the desired velocity, the command being delivered to at least one other hydraulic circuit to reduce the actual velocity of at least one other hydraulic cylinder associated with the at least one other hydraulic circuit to maintain the desired ratio of flow of hydraulic fluid.
